(19) United States
(12) Patent Application Publication
(10) Pub. No.: US 2005/0183918 A1
(43) Pub. Date: Aug. 25, 2005

(54) Ratchet paw module structure

(76) Inventor: Tien Wang Hou, Nantou Hsien (TW)

Correspondence Address: Tien Wang Hou, P.O. Box 82-144, Taipei, TW

(21) Appl. No.: 10/784,993

(22) Filed: Feb. 25, 2004

(51) Int. Cl. F16D 41/12; F16D 41/30

(52) U.S. Cl. 192/46; 192/64; 192/69.1

(57) ABSTRACT

A ratchet paw module structure is disclosed. The module comprises a ratchet block seat and a ratchet seat, the ratchet block seat including a ratchet block module and the ratchet seat having a series of ratchet teeth corresponding to the ratchet paw module allowing the ratchet seat to engage or disengage correspondingly, characterized in that the ratchet block seat includes at least two groups of ratchet block modules, and each of the ratchet blocks of the ratchet block module have a distance, and the ratchet block is positioned in adjacent to the ratchet block module and the engaging position of the ratchet teeth on the ratchet seat is displaced eccentrically within the range of one ratchet teeth width; whereby when the ratchet block engages the ratchet teeth, the subsequent ratchet block is displaced eccentrically within the range of the ratchet teeth to minimize the reverse distance of rotation. The structure reduces the distance at a disengagement position to an engaging position and this minimized the distance of disengagement of the ratchet paw.

### BACKGROUND OF THE INVENTION

(a) Technical Field of the Invention

The present invention relates to ratchet paw module, and in particular, to a ratchet paw which allows the disengagement distance of the ratchet block seat and the ratchet seat to be shortened. This will reduce the momentum caused by disengaging rotation or free rotation of the ratchet paw and thus the longevity of the ratchet paw is improved.

(b) Description of the Prior Art

Ratchet paw module is commonly used in rotating components to provide unidirectional movement, such as the flywheel used in bicycles or exercisers. FIG. 1 is a conventional ratchet paw structure used in flywheel. The ratchet paw structure comprises a ratchet block seat 10 and a ratchet seat 15, and the ratchet block seat 10 has a ratchet block module. On the ratchet block seat 10, the ratchet block module has three equidistant teeth slots 11, and a binding rim 13 is used to tight the ratchet block 12 to the corresponding teeth slot 11. The ratchet block seat 10 is mounted with a ratchet seat 15 having teeth disc at the outer edge thereof using a wheel cover 19. The inner edge of the ratchet seat 15 is formed with a series of ratchet teeth 16 corresponding to the ratchet block 12 to allow engagement or free engagement of the ratchet teeth seat 15 with corresponding ratchet block seat 10, and between the ratchet teeth seat 15 and the ratchet block seat 10 with the wheel cover, and ball bearing modules 17, 18 are provided to allow smooth rotation.

As shown in FIGS. 2, 2A, when the ratchet teeth seat rotates a distance of half of the ratchet teeth 16 with respect to the ratchet block seat 10 and the ratchet teeth seat 15 is to be reversed to engage with the ratchet block seat 10, the ratchet teeth seat 15 must pass the free engagement of the width of the half of the ratchet teeth 16 in order to be in engagement. As shown in FIGS. 3, 3A, when the ratchet teeth seat 15 rotates freely for more than ¾ of the ratchet teeth 16 with respect to the ratchet block seat 10, the ratchet teeth seat 15 must reverse 2/4 of the width of the ratchet teeth 16 in order to proceed with a smooth engagement.

As a result of longer distance of rotation, a larger momentum is generated and this momentum will damage the ratchet block or the ratchet teeth 16 and the reliability and longevity will be impaired. Accordingly, it is an object of the present invention to provide a ratchet paw module which mitigates the above drawbacks.

### SUMMARY OF THE INVENTION

Accordingly, it is an object of the present invention to provide a ratchet paw structure comprising a ratchet block seat and a ratchet seat, the ratchet block seat including a ratchet block module and the ratchet seat having a series of ratchet teeth corresponding to the ratchet paw module allowing the ratchet seat to engage or disengage correspondingly, characterized in that the ratchet block seat includes at least two groups of ratchet block modules, and each of the ratchet blocks of the ratchet block module have a distance, and the ratchet block is positioned in adjacent to the ratchet block module and the engaging position of the ratchet teeth on the ratchet seat is displaced eccentrically within the range of one ratchet teeth width; whereby when the ratchet block engages the ratchet teeth, the subsequent ratchet block is displaced eccentrically within the range of the ratchet teeth to minimize the reverse distance of rotation.

Still another object of the present invention is to provide a ratchet paw module structure, wherein the distance of the free disengagement of the ratchet block seat in the course of reverse rotate is effectively shorten and the momentum due to free disengagement of rotation is reduced.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of a conventional ratchet paw module.

FIGS. 2, 2A are schematic views showing the movement of the conventional ratchet paw module.

FIGS. 3, 3A are another schematic views showing the movement of the conventional ratchet paw module.

FIG. 4 is a perspective exploded view of the ratchet paw module in accordance with the present invention.

FIGS. 5, 5A, 5B are schematic views showing the operation of the ratchet paw module in accordance with the present invention.

FIGS. 6, 6A, 6B are another schematic views showing the operation of the ratchet paw module in accordance with the present invention.

FIG. 7 is a perspective exploded view of another preferred embodiment in accordance with the present invention.

FIG. 8 is a sectional schematic view of another preferred embodiment in accordance with the present invention.

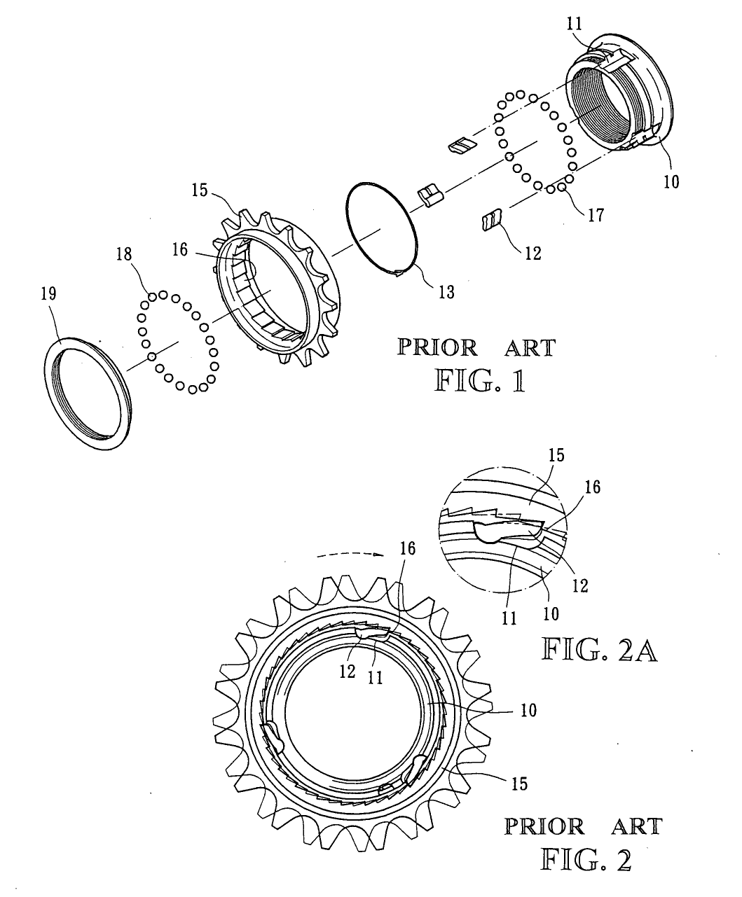

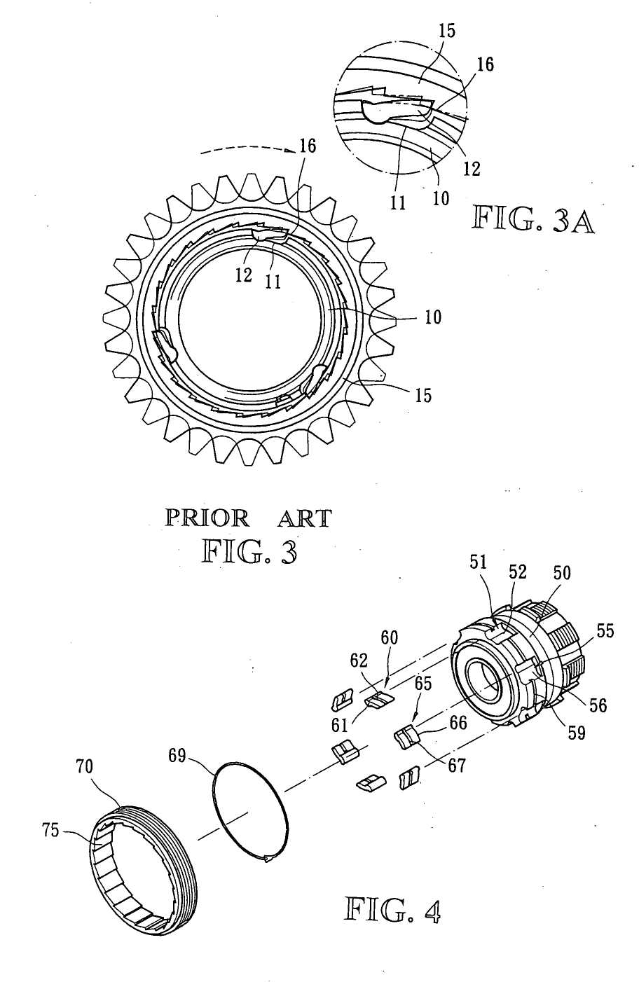

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Referring to FIG. 4, the ratchet paw structure of the present invention includes a ratchet block seat 50 and a ratchet teeth seat 70, and the ratchet block seat 50 is provided with a ratchet block module 60, and the ratchet block seat 50 can be rotated in engagement with the ratchet teeth seat 70 or rotated freely without engagement. The inner edge of the ratchet teeth seat 70 is a series of ratchet teeth 75 corresponding with a first ratchet block module 60 for the ratchet teeth seat 70 to be in engagement with the ratchet block seat 50 to rotate or to rotate freely without engagement. The ratchet block seat 50 or the ratchet teeth seat 70 can be a driving component or a driven component. For instance, when it is used in flywheel of a bicycle, the ratchet block seat 50 is a driven component and if the outer edge of the ratchet teeth seat 70 is provided with a teeth disc, it becomes a driving component.

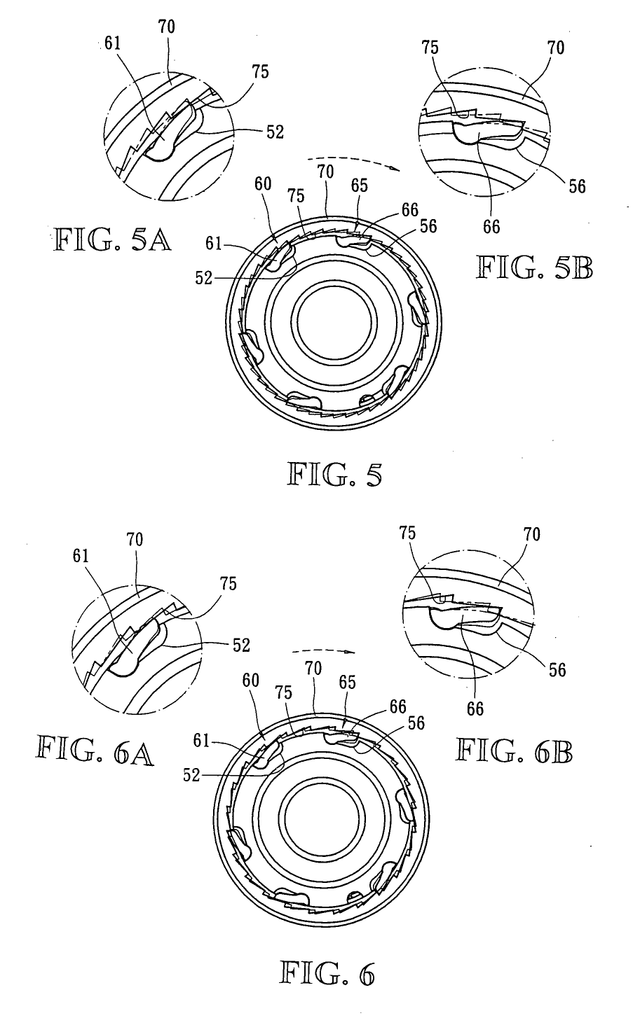

As shown in FIG. 4, the ratchet block seat 50 includes at least two groups of teeth slot modules 51, 55. The first and the second teeth slot modules 51, 55 are formed from three teeth slots 52, 56 of equidistance and angle. The external edge of the ratchet block seat 50 is a circular slot 59 transverse the middle section of the teeth slots 52, 56 of the first teeth slot modules 51, 55. The first and second teeth slot modules 51, 55 are respectively mounted with a first ratchet block module 60 and a second ratchet block module 65, wherein the first ratchet block module 60 is a ratchet block 61 mounted within the teeth slot 52 of he first teeth slot 51. Further, the second ratchet block module 65 is a ratchet block 65 mounted within the teeth slot 56 of the second teeth slot module 55 of the ratchet block seat 50, and the middle section of the ratchet block 61, 66 of the first and the second ratchet block module, 60, 65 are respectively formed into an engaging slot 62, 67 corresponding to the circular slot 59 of the ratchet block seat 50, so that a binding rim 69 can be used to let the ratchet block 61, 66 to be restored outward automatically. Further, the ratchet block 66 of the second ratchet block module 65 is positioned subsequently to the ratchet block 61 of the first ratchet block module 60, wherein the ratchet block 66 of the second ratchet block module 65 is exactly at the ratchet block 61 to engage with the ratchet teeth seat 70, a width of one ratchet teeth 75 is moved eccentrically forward or backward. In the present invention, a width of half ratchet teeth 75 is used as an example, as shown in FIGS. 5, 5A and 5B.

Thus, when the ratchet block 61 of the first ratchet block module 60 engages with the ratchet teeth 75 of the ratchet teeth seat 70, the ratchet block 66 of the second ratchet block module 65 is appropriately corresponding to half of the ratchet teeth 75, and the structure provides a shorter distance of reverse rotation.

FIGS. 5, 5A, 5B and FIGS. 6, 6A, 6B indicate the application of the present ratchet paw module structure. When the ratchet paw module structure is freely rotated and it is to be shifted to a reverse rotation, when the ratchet block 61 is in engagement with the ratchet teeth 75 of the ratchet teeth seat 70, the ratchet block 66 of the second ratchet block module 65 is exactly at a position corresponding to the half of the width of the ratchet teeth 75. When the ratchet block 61 is at a position, which is half of the ratchet teeth 75, the ratchet block 66 of the second ratchet block module can engage with the ratchet teeth 75 of the ratchet teeth seat 70. This will effectively shorten the distance of reverse rotation.

As the distance of reverse rotation has been shortened to half of the ratchet teeth 75, the momentum thus generated is greatly reduced. Thus, the ratchet teeth 75, the ratchet blocks 61, 66 can be protected without being damaged by the momentum.

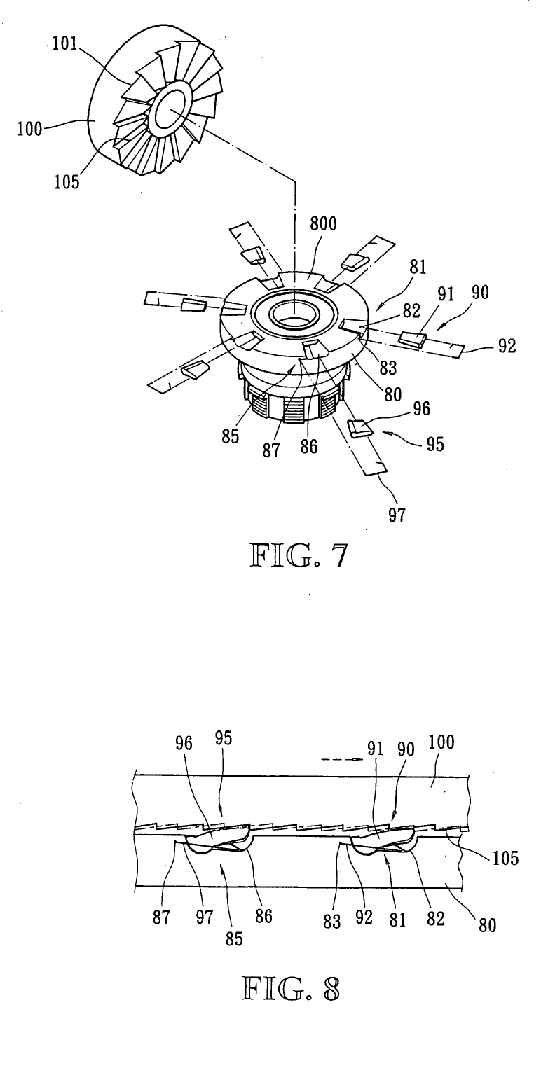

FIGS. 7 and 8 show another preferred embodiment. The ratchet paw module structure includes a ratchet block seat 80 and a ratchet teeth seat 100. The end face 800 of the ratchet block seat 80 is provided with a first ratchet block module 90. The ratchet block seat 80 will engage with the ratchet teeth seat 100 or not engage with the ratchet teeth seat 100 to rotate freely The corresponding end face 101 of the ratchet teeth seat 100 is formed into a series of ratchet teeth 105 corresponding to the first ratchet block module 90 so that the ratchet teeth seat is engaged with respect to the ratchet block seat 80 or rotate freely with respect to the ratchet block seat 80.

Further, the ratchet block seat 80 includes at least two groups of teeth slot modules 81, 85, wherein the first and the second teeth slot modules 81, 85 are formed from teeth slots 82, 86 having three equidistance and angle. One side of each teeth slots 82, 86, adjacent to the circumferential edge of the ratchet block seat 80, is formed with a fastening slot 83, 87, and the first and the second teeth slot module 81, 85 are respectively mounted with a first ratchet block module 90 and a second block module 95. The first ratchet block module 90 is a teeth slot 82 of the first teeth slot module 81 of the ratchet block seat 80 being mounted with a ratchet block 91. Further, the second ratchet block 95 is the teeth slot 86 of the second teeth slot module 85 of the ratchet block seat 80 being mounted with a ratchet block 96, and the ratchet blocks 91 and 96 make use of elastic elements 92, 97 to fasten on the fastening slots 83, 87 of the ratchet block seat 80 so as to provide the ability of automatic restoration of the ratchet blocks 91, 96. In addition, he ratchet block 96 is mounted subsequently to the ratchet block 91 of the first ratchet block module 90. The ratchet block 96 of the second ratchet block module 95 is appropriately positioned at the ratchet teeth seat 100 engaged by the ratchet block 91, it moves eccentrically forward or backward a width distance of one ratchet teeth. In the preferred embodiment, half the width of the ratchet teeth 105 is used as an example.

Thus, when the ratchet block 91 engages the ratchet teeth 105, the ratchet block 96 is exactly engaged at half the position of the corresponding ratchet teeth 105. This will also allow a shortening of distance of reverse rotation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A ratchet paw structure comprising a ratchet block seat and a ratchet seat, the ratchet block seat including a ratchet block module and the ratchet seat having a series of ratchet teeth corresponding to the ratchet paw module allowing the ratchet seat to engage or disengage correspondingly, characterized in that:
the ratchet block seat includes at least two groups of ratchet block modules, and each of the ratchet blocks of the ratchet block module have a distance, and the ratchet block is positioned in adjacent to the ratchet block module and the engaging position of the ratchet teeth on the ratchet seat is displaced eccentrically within the range of one ratchet teeth width;
whereby when the ratchet block engages the ratchet teeth, the subsequent ratchet block is displaced eccentrically within the range of the ratchet teeth to minimize the reverse distance of rotation.

2. The ratchet paw structure of claim 1, wherein the ratchet block seat includes a first teeth slot module and a second teeth module, and the first teeth slot module and the second teeth slot module are respectively provided with a first ratchet block module and a second ratchet block module formed from a series of ratchet blocks, and the ratchet block of the second ratchet block module and the ratchet block of the first ratchet block module are mounted subsequently and when the ratchet block of the second ratchet block module is exactly positioned at the ratchet teeth of the ratchet seat engaged by the ratchet block of the first ratchet block module, the ratchet block of the second ratchet block module moves forward or backward eccentrically half the width of the ratchet teeth so as to reduce the reverse distance of the ratchet seat.

3. The ratchet paw structure of claim 1, wherein the number of ratchet slots of each ratchet slot module and the number of ratchet blocks of the ratchet block module are respectively three, and the inclined angle is 120 degree.

3. The ratchet paw structure of claim 1, wherein the ratchet block module of the ratchet block seat is formed at the end face thereof, and the ratchet teeth of the ratchet seat is formed at the corresponding end face.
